(19) United States
(12) Patent Application Publication
(10) Pub. No.: US 2008/0110654 A1
(43) Pub. Date: May 15, 2008

(54) Composite drilling tool

(76) Inventor: Chih-Ching Hsieh, Taichung (TW)

Correspondence Address: Chih-Ching HSIEH, Box 8-24, 235 Chung-Ho, Taipei, omitted

(21) Appl. No.: 11/598,275

(22) Filed: Nov. 13, 2006

(51) Int. Cl. B23Q 5/00

(52) U.S. Cl. 173/16; 173/47

(57) ABSTRACT

A composite drilling tool comprises: a handle; and a driving portion installed at one end of the handle; the driving portion including a pneumatic portion, an electromotive portion, a coil and a battery; the pneumatic portion and the electromotive portion serving to drive the drilling rod through air power or electric power; the power of the electromotive portion being from the battery; the coil enclosing the drilling rod; when the drilling rod rotates, the magnetic flux from the magnetic unit will change so as to induce current in the coil and thus the battery is charged; and a drilling rod installed in the driving portion with a part being embedding into the driving portion and a part being protruded out of the driving portion for assembling a drilling head of various forms; and the drilling rod being installed with a magnetic unit.

### FIELD OF THE INVENTION

The present invention relates to drilling tools, and particularly to a composite drilling tool which has a pneumatic portion and an electromotive portion so as to drive a drilling rod of a drilling tool pneumatically or electromotively.

### BACKGROUND OF THE INVENTION

In the prior art, the pneumatic drilling tool and electromotive drilling tool are not combined. Thus the workers must buy two kinds of drilling tools for being used in various working fields. However the cost is high and a great space is necessary in carrying or storage.

Furthermore, the pneumatic tool is connected with an air compressor and thus a connecting wire is necessary. This is inconvenient to users. Thereby the movement of the drilling tool is limited by the connecting wire.

The electromotive drilling tool can supply power from batteries and thus no connecting wire is necessary, while the power of the batteries are confined and thus the they must be charged frequently. Thus will affect the work.

### SUMMARY OF THE INVENTION

Accordingly, the primary object of the present invention is to provide a composite drilling tool which has a pneumatic portion and an electromotive portion so as to drive a drilling rod of a drilling tool pneumatically or electromotively.

To achieve above objects, the present invention provides a composite drilling tool comprising: a handle; a driving portion installed at one end of the handle; the driving portion including a pneumatic portion, an electromotive portion, a coil and a battery; the pneumatic portion and the electromotive portion serving to drive the drilling rod through air power or electric power; the power of the electromotive portion being from the battery; the coil enclosing the drilling rod; when the drilling rod rotates, the magnetic flux from the magnetic unit will change so as to induce current in the coil and thus the battery is charged; and a drilling rod installed in the driving portion with a part being embedding into the driving portion and a part being protruded out of the driving portion for assembling a drilling heads of various forms; and the drilling rod being installed with a magnetic unit. The rotation of the drilling rod will induce the magnetic flux of the magnetic unit varies so as to induce current in the coil and thus power is stored in the battery; the power of the battery serves to drive the drilling rod.

In using of the present invention, when the distal end of the handle is connected to the connecting wire and the driving switch actuates the driving portion, the driving portion will drive drilling rod through the power from the pneumatic portion and the air compressor. At the same time, the magnetic flux variation of the magnetic unit will induce current in the coil so that power will be stored in the battery. When the power of the battery is sufficient, the connecting wire can be pulled out and the driving switch can be driven from the electromotive portion which is actuated by the battery. Thus it is not confined by the length of the connecting wire. Thereby the object of environment protection is achieved.

The various objects and advantages of the present invention will be more readily understood from the following detailed description when read in conjunction with the appended drawing.

### BRIEF DESCRIPTION OF THE DRAWINGS

FIG. 1 is a lateral schematic view of the composite drilling tool of the present invention.

FIG. 2 is a schematic view about the composite drilling tool of the present invention.

FIG. 3 is a structural block diagram of the composite drilling tool of the present invention.

FIG. 4 is a schematic view showing the use of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

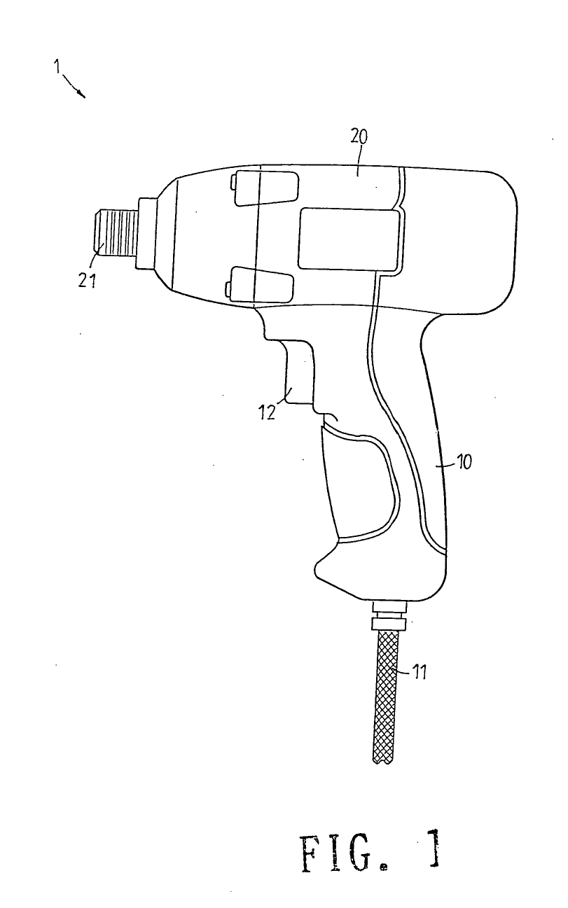

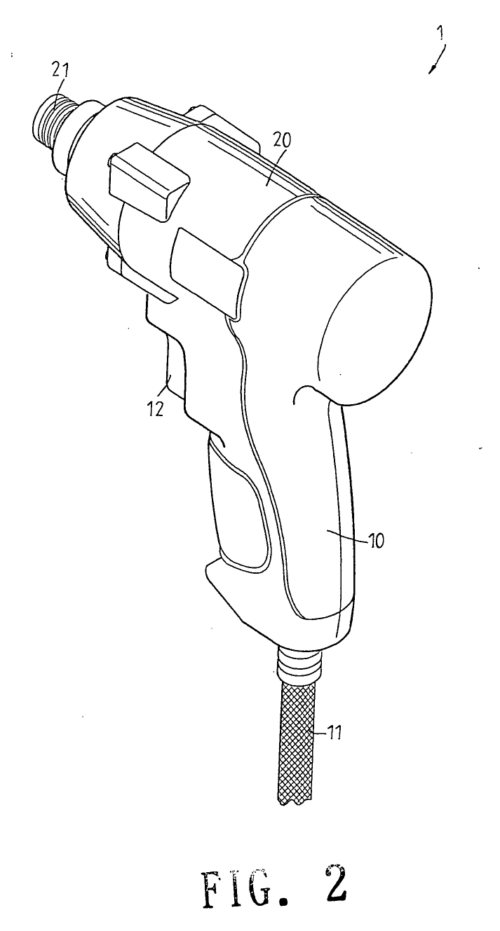

A composite drilling tool 1 of the present invention is illustrated with referring to FIGS. 1 and 2. The present invention has the following elements.

A handle 10 can be connected with a connecting wire 11 at a distal end thereof for being further connecting to an air compressor (not shown) as a power source. The handle 10 is installed with a driving switch 12.

A driving portion 20 is installed at one end of the handle 10 and is vertically extended to the handle 10. The driving switch 12 can actuate the driving portion 20. The driving portion 20 includes a pneumatic portion 22, an electromotive portion 23, a coil 24 and a battery 25. The pneumatic portion 22 and the electromotive portion 23 serve to drive the drilling rod 21 through air power or electric power. The air passes through the air compressor to the connecting wire 11 and then to the pneumatic portion 22. The power of the electromotive portion 23 is from the battery 25. The coil 24 encloses the drilling rod 21. When the drilling rod 21 rotates, the magnetic flux from the magnetic unit 211 will change so as to induce current in the coil 24 and thus the battery 25 is charged.

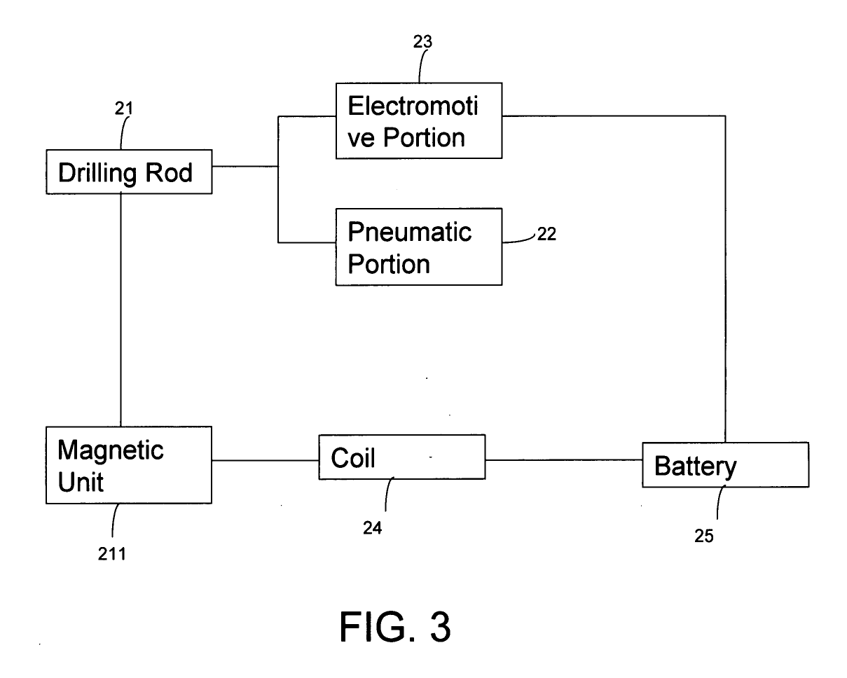

Referring to FIGS. 1 and 3, a drilling rod 21 is installed in the driving portion 20 with a part being embedded into the driving portion 20 and a part being protruded out of the driving portion 20 for assembling a drilling head of various forms. The drilling rod 21 is installed with a magnetic unit 211.

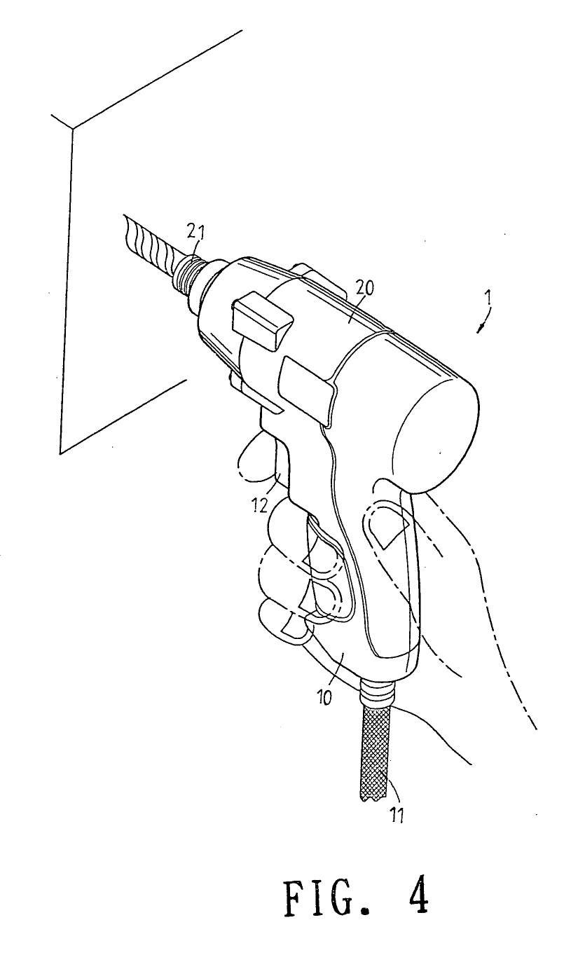

In using of the present invention, referring to FIG. 4, when the distal end of the handle 10 is connected to the connecting wire 11 and the driving switch 12 actuates the driving portion 20, the driving portion 20 will drive drilling rod 21 through the power from the pneumatic portion 22 and the air compressor. At the same time, the magnetic flux variation of the magnetic unit 211 will induce current in the coil 24 so that power will be stored in the battery 25. When the power of the battery 25 is sufficient, the connecting wire 11 can be pulled out and the driving switch 12 can be driven from the electromotive portion 23 which is actuated by the battery 25. Thus it is not confined by the length of the connecting wire 11. Thereby the object of environment protection is achieved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A composite drilling tool comprising:
a handle;
a driving portion installed at one end of the handle; the driving portion including a pneumatic portion, an electromotive portion, a coil and a battery; the pneumatic portion and the electromotive portion serving to drive the drilling rod through air power or electric power; the power of the electromotive portion being from the battery; the coil enclosing the drilling rod; when the drilling rod rotates, the magnetic flux from the magnetic unit will change so as to induce current in the coil and thus the battery is charged;
a drilling rod installed in the driving portion with a part being embedding into the driving portion and a part being protruded out of the driving portion for assembling a drilling head of various forms; and the drilling rod being installed with a magnetic unit;
wherein the rotation of the drilling rod will induce the magnetic flux of the magnetic unit varies so as to induce current in the coil and thus power is stored in the battery; and the power of the battery serves to drive the drilling rod.

2. The composite drilling tool as claimed in claim 1, wherein the handle is connected with a connecting wire at a distal end thereof for being further connecting to an air compressor as a power source.

3. The composite drilling tool as claimed in claim 1, wherein the handle is installed with a driving switch; and the driving switch can actuate the driving portion.
